(19) United States
(12) Patent Application Publication
(10) Pub. No.: US 2006/0139473 A1
(43) Pub. Date: Jun. 29, 2006

(54) Method of providing OSD in mobile communication terminal using Q-camera

(75) Inventor: Yong Sik Shin, Seoul (KR)

Correspondence Address: Charles N.J. Ruggiero;Ohlandt, Greeley, Ruggiero & Perle, L.L.P., One Landmark Square, 10th Floor, Stamford, CT, 06901-2682, US

(73) Assignee: PANTECH CO., LTD.

(21) Appl. No.: 11/319,877

(22) Filed: Dec. 28, 2005

(30) Foreign Application Priority Data
Dec. 28, 2004 (KR) 10-2004-0114161

(51) Int. Cl. H04N 5/222

(52) U.S. Cl. 348/333.09; 348/333.11

(57) ABSTRACT

Disclosed is a method of providing an on screen display (OSD) in a mobile communication terminal using a Q-camera. The method comprises: entering into a viewfinder mode, and receiving image data inputted from a camera sensor as image data of the viewfinder mode when an operation mode of the mobile communication terminal switches into a camera mode; if an OSD menu is set, overwriting an OSD image corresponding to a setting value of the OSD menu with the image data of the viewfinder mode, and then updating a display screen of the mobile communication terminal with the overwritten data; and encoding the image data of the viewfinder mode to perform the photographing if there is a request for photographing. According to the method of this invention, only the actually changed OSD image is selectively employed to overwrite with the image data of the viewfinder mode to update the display screen, and thereby a partial OSD function can be realized.

### CROSS-REFERENCE TO RELATED APPLICATION

The present application is claiming priority of Korean Patent Application No. 10-2004-0114161, filed on Dec. 28, 2004, the content of which is herein incorporated by reference.

### BACKGROUND OF THE INVENTION

1. Field of the Invention

The present invention relates to a method of providing an On Screen Display (OSD) in a mobile communication terminal using a Q-camera, and more particularly to a method of providing an OSD in a mobile communication terminal using a Q-camera allowing the terminal to provide a partial OSD function.

2. Background of the Related Art

As a development of technology for making mobile communication terminal, a complex mobile communication terminal having functions which have been provided by other electronic device, such as radio, TV, MP3 and the like, has been developed. In particular, a camera phone having a camera function added to the mobile communication terminal has been developed and widely used at present.

In the mean time, in technical field of semiconductors, there is a trend of which diverse functions are mounted in a single chip to reduce the number of parts, thereby reducing size and production cost of a product including the single chip. According to the trend, in technical field of mobile communication terminals, a function supporting digital camera referred to as ‘Q-camera’ comes to mount in a main chipset which provides a voice call function that is an inherent function of the mobile communication terminal, instead of mounting a single exclusive Back End IC capable of providing diverse camera functions.

However, a mobile communication terminal using the Q-camera cannot provide a partial OSD function in providing an OSD function contrary to a mobile communication terminal using the single exclusive Back End IC. Thereby, the terminal cannot help displaying an OSD menu using an overwrite function rather than an overlay function.

FIG. 1 is a flowchart for illustrating a method of providing an OSD in a mobile communication terminal using a Q-camera according to the prior art. Hereinafter, the OSD providing method of the prior art will be described with reference to FIG. 1.

Firstly, when an operation mode of the mobile communication terminal is switched into a camera mode by a user's key manipulation (S10), it is checked whether an OSD menu has been set or not, before entering into a viewfinder mode (S12).

As a result of the check of S12, if the OSD menu has not been set, a LCD screen of the mobile communication terminal is updated with image data inputted through a camera sensor as image data of the viewfinder mode (S14).

In the mean time, as a result of the check of S12, if the OSD menu has been set, it is searched all OSD images corresponding to setting values set through the OSD menu to select an OSD image corresponding to the setting value currently applied (S16), and the selected OSD image and the image data inputted through the camera sensor are overwritten (S18). After that, the overwritten data is used as the image data of the viewfinder mode to update the LCD screen (S20).

In the mobile communication terminal using the Q-camera, as can be seen from S20, since a partial OSD function is not supported in the prior method for providing OSD the terminal should have OSD images corresponding to all the setting values that can be set through the OSD menu. For example, if the terminal has two menus capable of setting seven-levels of brightness and seven-levels of shades, the mobile communication terminal should have 49 OSD images: {(brightness, shade): (−3, −3), (−3, −2), (−3, −1), (−3, 0), (−3, 1), (−3, 2), (−3, 3), . . . , (3, −3), (3, −2), (3, −1), (3, 0), (3, 1), (3, 2), (3, 3)}.

In addition, since each size of the OSD images should be same as a size of the LCD, if it is assumed that a size of a LCD is 220×176 (byte), a single OSD image occupies about 77 kbyte of memory. In addition, the OSD image should be overwritten logically as much as 220×176 (byte) every time that the setting value of the menu is changed, in order to overwrite each of the OSD images with the image data inputted through the camera sensor.

When a user requests a photographing (S22) after updating the LCD screen (S20) as described above, it is checked whether the OSD image is applied to the image data of the viewfinder mode or not (S24).

As a result of the check of S24, if the OSD image is applied, since the OSD image should not be included in the image data of the viewfinder mode that is encoding data, the applied OSD image is deleted (S26) and then the data of which OSD image has been deleted are encoded (S28).

After performing the photographing through S22 to S28, when the operation mode of the terminal enters into a re-photographing mode (S30), if the OSD menu is set, the process proceeds to S12 since the OSD image should be again displayed on the LCD screen.

As described above, according to the mobile communication terminal using the Q-camera of the prior art, the terminal should have the OSD images corresponding to all the setting values capable of being set through the OSD menu, and the size of the OSD image is same as that of the LCD. Accordingly, the OSD images occupy considerable region of the limited memory. In addition, when a menu is added, all OSD images corresponding to the setting values of the added menu also should be added.

And, if the OSD menu is set, whenever it takes a photographing, an encoding process is performed after deleting the OSD image so that the data encoded by the encoding process do not include the OSD image. In addition, when the operation mode enters into the re-photographing mode, a setting of the OSD menu should be performed again, so that the whole system is applied with high load in photographing and thus instability can be caused in the system.

### SUMMARY OF THE INVENTION

Accordingly, the present invention has been made to solve the above problems of the prior art. An object of the present invention is to provide a method of providing OSD in a mobile communication terminal using a Q-camera, wherein the method allows the terminal to embody a partial OSD function by selectively employing only an OSD image actually changed and overwriting the selected image with image data of a viewfinder mode to update a LCD screen.

In order to achieve the above objects, there is provided a method of providing an on screen display (OSD) in a mobile communication terminal using a Q-camera, comprising: entering into a viewfinder mode, and receiving image data inputted from a camera sensor as image data of the viewfinder mode when an operation mode of the mobile communication terminal switches into a camera mode; if an OSD menu is set, overwriting an OSD image corresponding to a setting value of the OSD menu with the image data of the viewfinder mode, and then updating a liquid crystal display (LCD) screen of the mobile communication terminal with the overwritten data; and encoding the image data of the viewfinder mode to perform the photographing if there is a request for photographing.

### BRIEF DESCRIPTION OF THE DRAWINGS

The above and other objects, features and advantages of the present invention will be more apparent from the following detailed description taken in conjunction with the accompanying drawings, in which:

FIG. 1 is a flowchart for illustrating a method of providing an OSD in a mobile communication terminal using a Q-camera, according to the prior art;

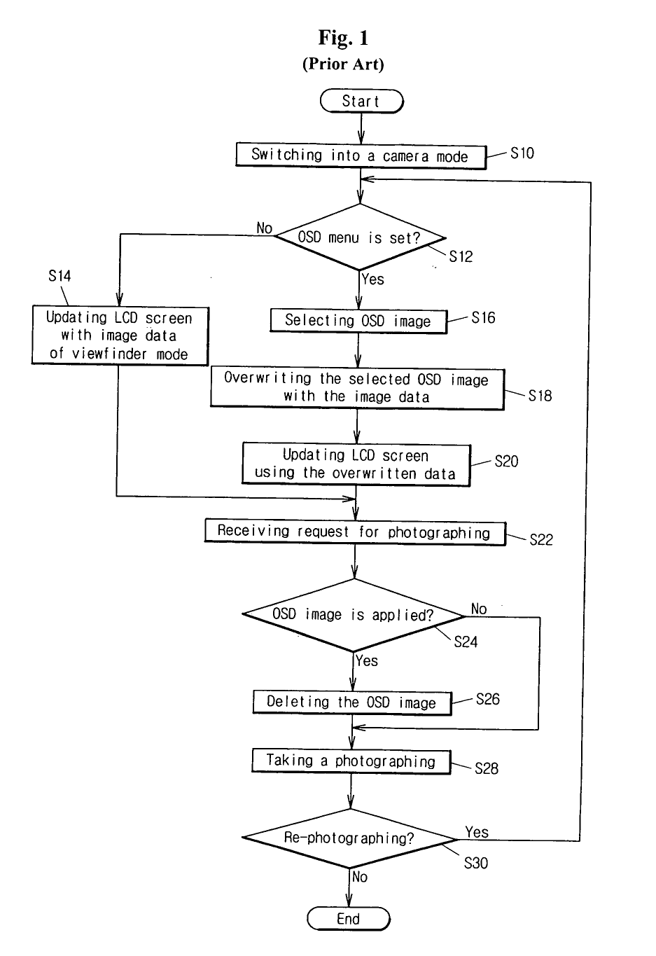

FIG. 2 is a flowchart for illustrating a method of providing an OSD in a mobile communication terminal using a Q-camera, according to an embodiment of the invention; and

FIG. 3 is a schematic diagram of an apparatus for embodying the method shown in FIG. 2.

### DETAILED DESCRIPTION OF THE PREFERRED EMBODIMENTS

Hereinafter, preferred embodiments of the present invention will be described with reference to the accompanying drawings. In the following description of the present invention, a detailed description of known functions and configurations incorporated herein will be omitted when it may make the subject matter of the present invention rather unclear.

According to the invention, OSD images for all setting values capable of being set through an OSD menu are separately provided with respect to each of the menus. In other words, according to the invention, a single OSD image displays only a corresponding single menu instead of displaying all menus in a lump. Accordingly, for example, if two menus capable of setting seven-levels of brightness and seven-levels of shades are provided, 7 OSD images for the brightness menu and 7 OSD images for the shade menu, i.e. total 14 OSD images are required, as against the prior art requiring 49 OSD images.

In addition, according to the invention, a size of the OSD image is reduced as small as a region in which each of the menus is substantially displayed, as against the prior art making a size of the OSD image be same as that of the LCD.

Thereby, if a mobile communication terminal has two menus capable of setting seven-levels of brightness and seven-levels of shades, and a LCD having a size of 220×176 (byte), a memory of (220×176)×(7×7)×2 (byte) is required since a size of the OSD image is same as that of the LCD, according to the prior art. However, according to the invention in the above case, since the size of the OSD image is reduced as small as a region in which each menu is substantially displayed, it is required (18×18)×(7×2)×2 (byte) of memory only, if a size of a region in which a single menu is displayed is 18×18 (byte).

In addition, when the OSD image is overwritten with image data of the viewfinder mode, if it is overwritten into a size of 18×18 (byte) which is a region to be displayed, rather than a size of 220×176 (byte) which is a whole size of the LCD, the overwrite time also can be reduced by (220×176)/(18×18).

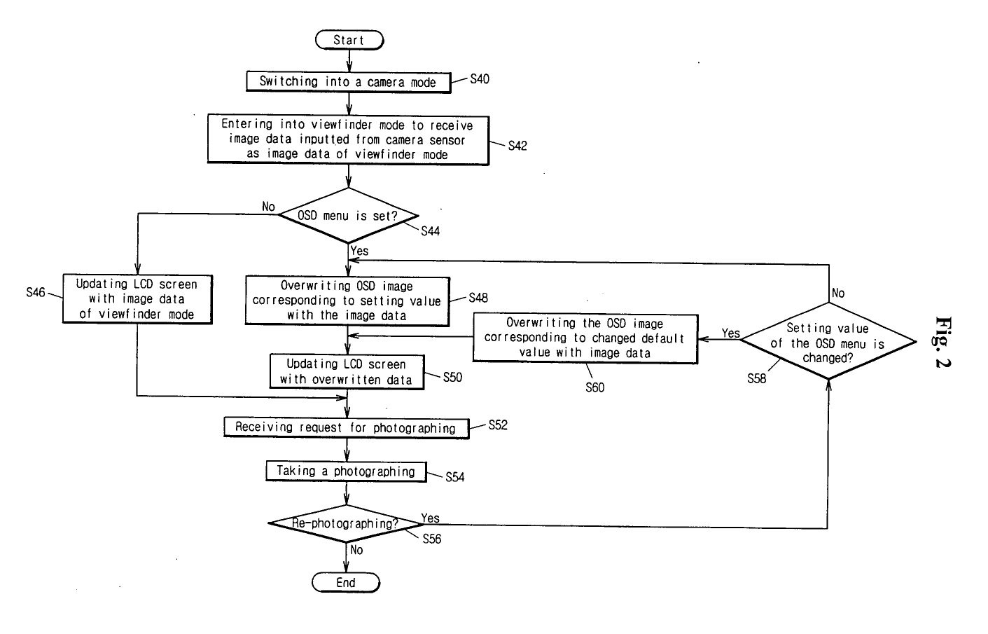

A method of providing OSD in mobile communication terminal using a Q-camera according to an embodiment of the present invention will be described with reference to FIG. 2.

Firstly, when an operation mode of the mobile communication terminal is switched into a camera mode by a user's key manipulation (S40), the terminal directly enters into a viewfinder mode. Then, the terminal receives image data inputted from a camera sensor as image data of the viewfinder mode (S42) and it is checked whether an OSD menu is set (S44).

As a result of the check of S44, if the OSD menu is not set, a LCD screen is updated with the image data of the viewfinder mode received via the step S42 (S46).

Meanwhile, as a result of the check of S44, if the OSD menu is set, the OSD image corresponding to the setting value of the OSD menu is overwritten with the image data of the viewfinder mode received in S42 (S48), and the LCD screen is updated with the overwritten data (S50).

The OSD image corresponding to the setting value of the OSD menu may be stored in a buffer for OSD image having the same size as LCD, and overwritten with the image data of the viewfinder mode, and then displayed on a LCD screen.

In addition, if at least two OSD menu are set, the overwriting of S48 for the OSD image and the image data can be performed with respect to each OSD menu. For example, in the event that both the OSD menu for ‘brightness’ and the OSD menu for ‘shade’ are set, the image data of the viewfinder mode may be separately overwritten with the OSD image corresponding to the setting value of the OSD menu for ‘brightness’ and the OSD image corresponding to the setting value of the OSD menu on ‘shade’, respectively.

Then, if a request for photographing is received from the user (S52), the image data of the viewfinder mode is encoded to perform the photographing (S54). In case of entering into re-photographing mode (S56), it is checked whether the setting value of the OSD menu is changed according to the user's key manipulation (S58).

As a result of the check of S58, if the setting value of the OSD menu is not changed, a process proceeds to S48 to update LCD screen through the overwriting of newly received image data of the viewfinder mode with an existing OSD image.

In S54, the data that will be encoded according to the request for photographing of the user is image data of the viewfinder mode. Like this, since data to be encoded is checked before applying of the OSD image, it is not required to repeat the processes of deleting and resetting the OSD image upon every photographing like the prior art.

Meanwhile, as a result of the check of S58, if the setting value of the OSD menu is changed, newly received image data of the viewfinder mode and the OSD image corresponding to the changed setting value of the OSD menu are overwritten together (S60), and the LCD screen is updated with the overwritten data (S50).

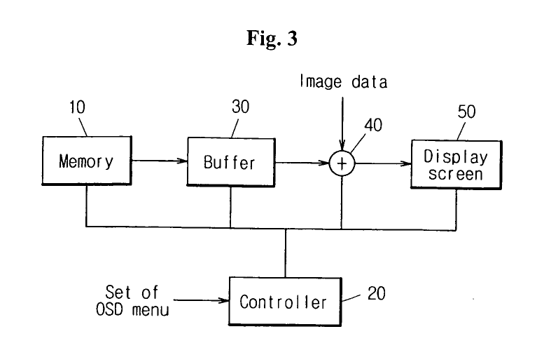

FIG. 3 is a schematic diagram of an apparatus for embodying the method shown in FIG. 2. As shown in FIG. 3, the apparatus for providing an OSD according to the invention comprises a memory 10, a controller 20, a buffer 30, an overwriter 40 and a display screen 50.

The memory 10 is an element for storing OSD images. Each of the OSD images stored in the memory is separately provided with respect to each menu instead of displaying all menus in a lump. For example, if two menus capable of setting seven-levels of brightness and seven-levels of shades are provided, 7 OSD images for the brightness menu and 7 OSD images for the shade menu, i.e. total 14 OSD images are stored in the memory.

In addition, each size of the OSD images stored in the memory may be set to have a size of a region that the OSD image is displayed on the display screen 50.

The controller 20 readouts an OSD image corresponding to the setting value of a OSD menu from the memory 10, if the OSD menu is set. Then, the controller 20 overwrites the OSD image with the image data of the viewfinder mode through the overwriter 40, and displays the overwritten data on the display screen 50.

The buffer 30 is an element for buffering the OSD image readout from the memory by the controller. The buffered OSD image is overwritten with the image data of the viewfinder mode by controlling of the controller 20.

As described above, according to the method and apparatus for providing an OSD in the mobile communication terminal using Q-camera, only the actually changed OSD image is selectively employed to overwrite with the image data of the viewfinder mode to update the LCD screen, and thereby a partial OSD function can be realized. Accordingly, memory consumption due to unnecessary OSD image can be reduced, and a preview speed can be improved because it is required to overwrite only the changed OSD image selectively. In addition, with a solution to instability of system caused by repeating deleting and resetting the OSD image upon every photographing, reliability of the system may be improved.

While the invention has been shown and described with reference to certain preferred embodiments thereof, it will be understood by those skilled in the art that various changes in form and details may be made therein without departing from the spirit and scope of the invention as defined by the appended claims.

What is claimed is:

1. A method for providing an On Screen Display (OSD) in a mobile communication terminal using a Q-camera, comprising:
entering into a viewfinder mode, and receiving image data inputted from a camera sensor as image data of the viewfinder mode when an operation mode of the mobile communication terminal switches into a camera mode;
if an OSD menu is set, overwriting an OSD image corresponding to a setting value of the OSD menu with the image data of the viewfinder mode, and then updating a display screen of the mobile communication terminal with the overwritten data; and
encoding the image data of the viewfinder mode to perform the photographing if there is a request for photographing.

2. The method according to claim 1, further comprising:
checking whether the setting value of the OSD menu is changed if there is a request for re-photographing after the photographing;
overwriting newly received image data of the viewfinder mode with the OSD image to update the display screen, if the setting value of the OSD menu is not changed as a result of the check; and
overwriting newly received image data of the viewfinder mode with the OSD image corresponding to the changed setting value of the OSD menu to update the display screen, if the setting value of the OSD menu is changed as a result of the check.

3. The method according to claim 1, wherein the OSD image is separately provided with respect to each menu.

4. The method according to claim 1, wherein each size of the OSD images is set to have a size of a region that the OSD image is displayed on the display screen.

5. The method according to claim 1, wherein the OSD image is stored in a buffer for OSD image having a same size as the display screen, and then overwritten with the image data of the viewfinder mode.

6. The method according to claim 1, wherein if the OSD menu is set to have two or more menus, the overwriting of the OSD image with the image data is separately conducted with respect to the respective OSD images corresponding to the setting value of each OSD menu.

7. An apparatus for providing an On Screen Display (OSD) in a mobile communication terminal using a Q-camera, comprising:
a memory for storing OSD images;
a controller for readout of an OSD image corresponding to a setting value of a OSD menu from the memory to overwrite the OSD image with an image data of a viewfinder mode of the terminal;
a buffer for buffering the OSD image readout from the memory by the controller;
an overwriter for overwriting the OSD image with the image data of the viewfinder mode; and
a display screen for displaying the overwritten data.

8. The apparatus according to claim 7, each of the OSD images stored in the memory is separately provided with respect to each menu.

9. The apparatus according to claim 7, each size of the OSD images stored in the memory is set to have a size of a region that the OSD image is displayed on the display screen.
